(19) United States
(12) Patent Application Publication
(10) Pub. No.: US 2015/0082897 A1
(43) Pub. Date: Mar. 26, 2015

(54) TOUCH SENSOR MODULE

(71) Applicant: SAMSUNG ELECTRO-MECHANICS CO., LTD., Suwon-Si (KR)

(72) Inventors: Seul Gi KIM, Suwon-Si (KR); Tae Hoon Kim, Suwon-Si (KR); Yong Ho Won, Suwon-Si (KR); Ho Joon Park, Suwon-Si (KR); Sung Kwon Wi, Suwon-Si (KR)

(73) Assignee: SAMSUNG ELECTRO-MECHANICS CO., LTD., Suwon-Si (KR)

(21) Appl. No.: 14/492,898

(22) Filed: Sep. 22, 2014

(30) Foreign Application Priority Data
Sep. 24, 2013 (KR) 10-2013-0113406

(51) Int. Cl. G06F 3/0354; G06F 3/044; G06F 3/045; G01L 1/22; G01L 1/14

(52) U.S. Cl. CPC G06F 3/03547; G01L 1/2268; G01L 1/14; G06F 3/045; G06F 3/044
USPC 73/776

(57) ABSTRACT

Disclosed herein is a touch sensor module, including: a flexible cable provided with a terminal part; an adhesive layer formed to transfer an electrical signal by being contacted on one surface of the terminal part; a base substrate including an electrode pad which is formed to correspond to the terminal part and formed to be contact on the other surface of the adhesive layer; and a first passivation layer coating one end of the electrode pad.

### CROSS REFERENCE TO RELATED APPLICATION

This application claims the benefit of Korean Patent Application No. 10-2013-0113406, filed on Sep. 24, 2013, entitled “Touch Sensor Module”, which is hereby incorporated by reference in its entirety into this application.

### BACKGROUND OF THE INVENTION

1. Technical Field

The present invention relates to a touch sensor module.

2. Description of the Related Art

With the development of computers using a digital technology, computer-aided devices have also been developed, and personal computers, portable transmitters and other personal information processors execute processing of texts and graphics using a variety of input devices such as a keyboard and a mouse.

With the rapid advancement of an information-oriented society, the use of computers has gradually been expanded; however, it is difficult to efficiently operate products using only a keyboard and a mouse which currently serve as input devices. Therefore, the necessity for a device, which has a simple configuration and less malfunction and is configured anyone to easily input information, has increased.

In addition, technologies for input devices have progressed toward techniques related to high reliability, durability, innovation, designing and processing, and the like, in addition to satisfying general functions. To this end, a touch sensor has been developed as input devices capable of inputting information such as texts and graphics.

The touch sensor is a device which is mounted on a display surface of a display such as an electronic organizer, a flat panel display device including a liquid crystal display (LCD) device, a plasma display panel (PDP), and an electroluminescence (El) element, and the like, and a cathode ray tube (CRT) to be used to allow a user to select desired information while viewing the display.

In addition, a type of the touch sensor may be classified into a resistive type, a capacitive type, an electro-magnetic type, a surface acoustic wave (SAW) type, and an infrared type.

These various types of touch sensors have been adapted for electronic products in consideration of a signal amplification problem, a resolution difference, a difficulty of designing and processing technology, optical characteristics, electrical characteristics, mechanical characteristics, anti-environment characteristics, input characteristics, durability, and economic efficiency. Currently, the resistive type touch sensor and the capacitive type touch sensor have been used in a wide range of fields.

As a specific example of a touch panel according to the prior art, there may be a touch sensor disclosed in Korean Patent Laid-Open Publication No. 10-2011-0107590.

Describing a structure of the touch sensor disclosed in the prior art in a specification of Korean Patent Laid-Opened Publication No. 10-2011-0107590, the touch sensor is configured to include a substrate, electrodes formed on the substrate, electrode wirings extending from the electrodes and gathered on one end of the substrate, and a controller connected to the electrode wirings through a flexible printed circuit board (FPCB) (hereinafter, referred to as ‘flexible cable’).

Here, the FPCB serves to transfer signals generated from the electrode to the controller through the electrode wirings. In this case, the FPCB is electrically connected to the electrode wirings by contacting the electrode wirings so as to transfer the signals. However, a poor contact between the FPCB and the electrode wiring frequently occurs due to an infiltration of moisture. As such, the poor contact frequently occurring may lead to a reduction in reliability of products.

### PRIOR ART DOCUMENT

### Patent Document

(Patent Document 1) KR10-2011-0107590 A

### SUMMARY OF THE INVENTION

The present invention has been made in an effort to provide a touch sensor module capable of preventing a short-circuit and a poor contact between an electrode pad and a flexible cable from occurring due to moisture, by forming passivation layers at both ends of the electrode pad.

According to a preferred embodiment of the present invention, there is provided a touch sensor module, including: a flexible cable provided with a terminal part; an adhesive layer formed to transfer an electrical signal by being contacted on one surface of the terminal part; a base substrate including an electrode pad which is formed to correspond to the terminal part and formed to be contact on the other surface of the adhesive layer; and a first passivation layer coating one end of the electrode pad.

The adhesive layer may use an anisotropic conductive film (ACF) or an anisotropic conductive adhesive (ACA).

A surface of the first passivation layer and a surface of the electrode pad may be formed to have a step so as to increase a hardening rate of the adhesive layer.

The first passivation layer may be formed to be larger by 1 μm to 8 μm than the surface of the electrode pad to increase the hardening rate and prevent infiltration of moisture.

The touch sensor module may further include: a second passivation layer formed to be coated along an outer circumferential surface of the electrode pad and formed to be equal to a height of the first passivation layer.

The touch sensor module may further include: a second passivation layer formed to coat the other end of the electrode pad and formed along an outer circumferential surface of the base substrate.

The first and second passivation layers may be formed on surfaces of both ends of the electrode pad to have a step so as to increase the hardening rate and are formed to have the same height.

The first passivation layer and the second passivation layer may be formed to be larger by 1 μm to 8 μm than the surface of the electrode pad to increase the hardening rate and prevent infiltration of moisture.

According to another preferred embodiment of the present invention, there is provided a touch sensor module, including: a base substrate provided with an electrode pad; a first passivation layer coating one end of the electrode pad in a thickness direction thereof; an adhesive layer coupling the first passivation layer with the electrode pad; and a flexible cable formed to correspond to the electrode pad and be electrically connected thereto in an area other than the first passivation layer.

The adhesive layer may use an anisotropic conductive film (ACF) or an anisotropic conductive adhesive (ACA).

A surface of the first passivation layer and a surface of the electrode pad may be formed to have different steps so as to increase a hardening rate of the adhesive layer.

The first passivation layer may be formed to be larger by 1 μm to 8 μm than the surface of the electrode pad to increase the hardening rate and prevent infiltration of moisture.

According to another preferred embodiment of the present invention, there is provided a touch sensor module, including: a base substrate provided with an electrode pad; a first passivation layer coating one end of the electrode pad in a thickness direction thereof; a second passivation layer coating the other end of the electrode pad in a thickness direction thereof; an adhesive layer crossing the first and second passivation layers to be filled in the electrode pad and coupled therewith; and a flexible cable formed to correspond to the electrode pad and be electrically connected thereto in an area other than the first passivation layer and the second passivation layer.

The adhesive layer may use an anisotropic conductive film (ACF) or an anisotropic conductive adhesive (ACA).

The first and second passivation layers may be formed on surfaces of both ends of the electrode pad to have a step so as to increase the hardening rate and may be formed to have the same height.

The first passivation layer and the second passivation layer may be formed to be larger by 1 μm to 8 μm than the surface of the electrode pad to increase the hardening rate and prevent infiltration of moisture.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a top coupling cross-sectional view of a touch sensor module according to a preferred embodiment of the present invention and a flexible cable (FPCB);

FIG. 2 is a bottom coupling cross-sectional view of the touch sensor module according to the preferred embodiment of the present invention and the FPCB;

FIG. 3 is a top/bottom partial view of a base substrate on which the touch sensor module according to the preferred embodiment of the present invention and the FPCB;

FIG. 4 is a cross-sectional view of a first modification example of the preferred embodiment of the present invention illustrated in FIG. 1;

FIG. 5 is a partially enlarged view of an electrode pattern illustrated in FIG. 4;

FIG. 6 is a cross-sectional view of a touch sensor module according to a second preferred embodiment of the present invention and the FPCB; and

FIG. 7 is a cross-sectional view of a second modification example of the preferred embodiment of the present invention illustrated in FIG. 6.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

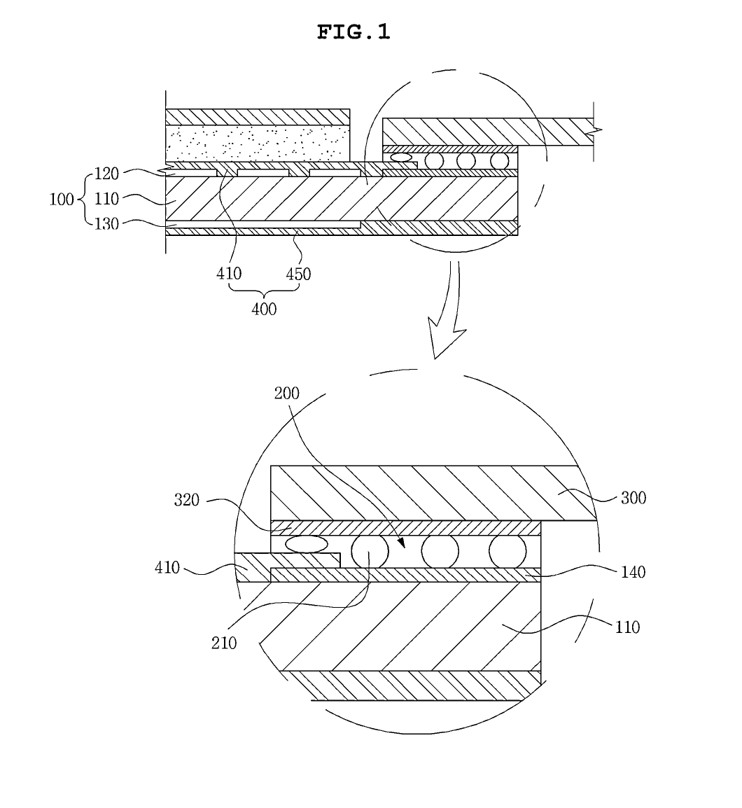

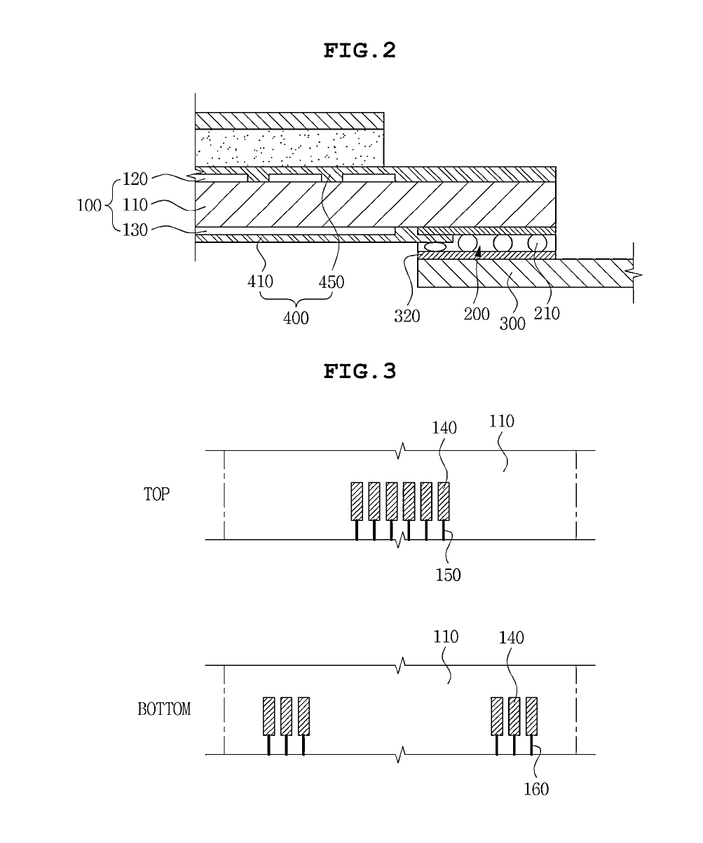

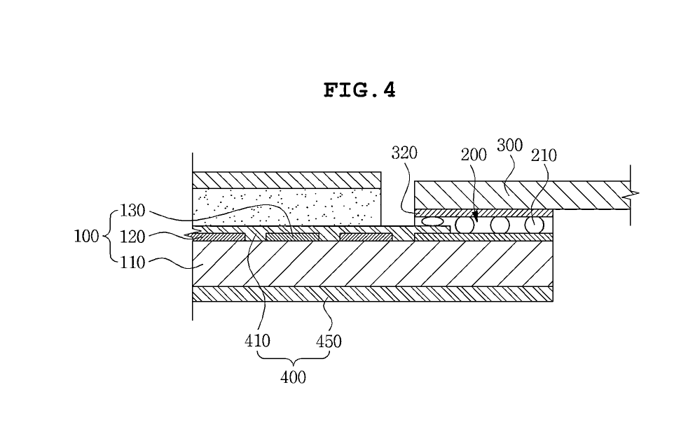

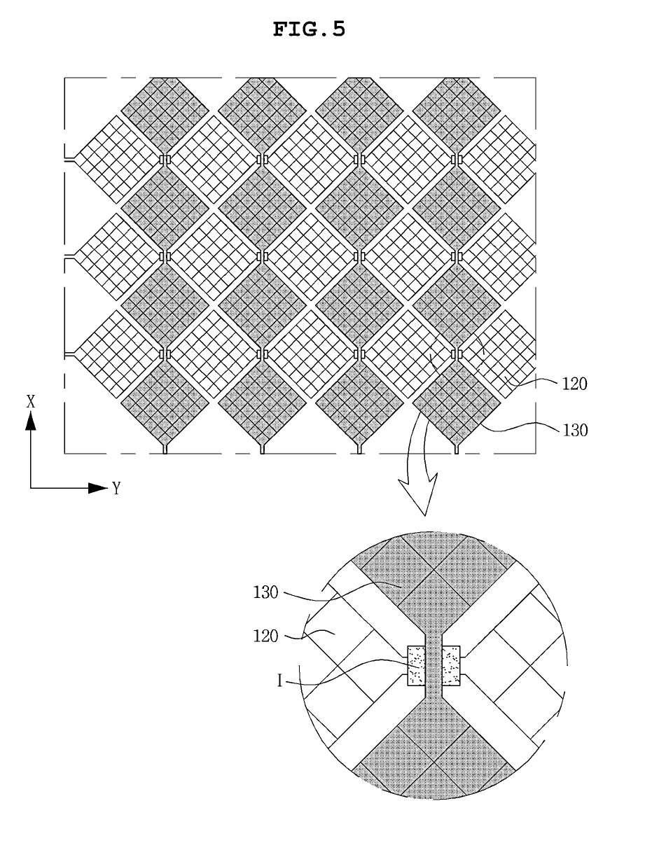

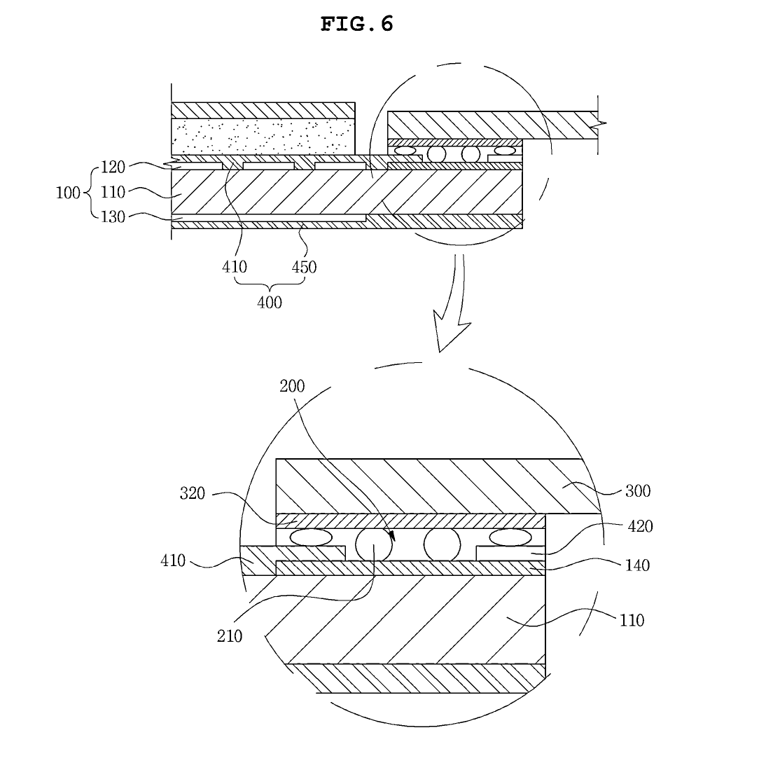

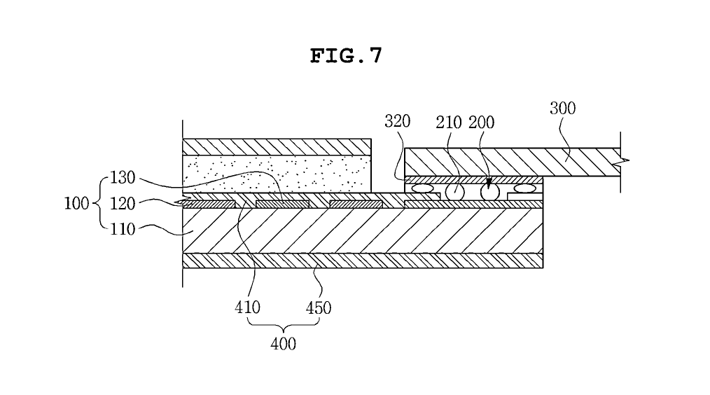

FIG. 1 is a top coupling cross-sectional view of a touch sensor module according to a preferred embodiment of the present invention and a flexible cable (FPCB); FIG. 2 is a bottom coupling cross-sectional view of the touch sensor module according to the preferred embodiment of the present invention and the FPCB; FIG. 3 is a top/bottom partial view of a base substrate on which the touch sensor module according to the preferred embodiment of the present invention and the FPCB; FIG. 4 is a cross-sectional view of a first modification example of the preferred embodiment of the present invention illustrated in FIG. 1; FIG. 5 is a partially enlarged view of an electrode pattern illustrated in FIG. 4; FIG. 6 is a cross-sectional view of a touch sensor module according to a second preferred embodiment of the present invention and the FPCB; and FIG. 7 is a cross-sectional view of a second modification example of the preferred embodiment of the present invention illustrated in FIG. 6.

The term ‘touch’ used in the present specification means a direct contact to a contact receiving surface and is to be broadly construed as a meaning that an input device considerably approaches the contact receiving surface.

A touch sensor module 1 according to a preferred embodiment of the present invention includes a flexible cable 300 provided with a terminal part 320, an adhesive layer 200 formed to transfer an electrical signal by being contacted on one surface of the terminal part 320, a base substrate 110 including an electrode pad 140 which is formed to correspond to the terminal part 320 and formed to be contact on the other surface of the adhesive layer 200, and a passivation layer 400 coating one end of the electrode pad 140.

The preferred embodiment of the present invention is to more improve anti-environment characteristics in addition to moisture resistance of the touch sensor module 1 and is to minimize an infiltration of moisture, and the like, into the touch sensor module 1. Therefore, the operation reliability of the touch sensor module 1 may be kept even under the high temperature and humidity environment, such that user convenience and a field of products to which the touch sensor module 1 is applied may be more diversified.

As a touch sensor 100 according to the preferred embodiment of the present invention, a resistive type touch sensor 100, a capacitive type touch sensor 100, or other various types of touch sensors 100 may be applied and a type and a kind of the touch sensor 100 are not particularly limited. However, in the touch sensor module 1 according to the preferred embodiment of the present invention, the capacitive type touch sensor 100 in which electrode patterns 120 and 130 are formed on both surfaces of the base substrate (transparent substrate) 110 will be described as one example.

Referring to FIG. 1, the base substrate 110 serves to provide a region in which the electrode patterns 120 and 130 and electrode wirings 150 and 160 are formed. In this configuration, the base substrate 110 is partitioned into an active region and a bezel region, in which the active region is a portion in which the electrode patterns 120 and 130 are formed to recognize the touch of the input device and is disposed at a center of the base substrate 110 and the bezel region is a portion in which the electrode wirings 150 and 160 extending from the electrode patterns 120 and 130 are formed and is disposed at an edge of the active region. In this case, the base substrate 110 needs to have a support force capable of supporting the electrode patterns 120 and 130 and the electrode wirings 150 and 160 and transparency to allow a user to recognize an image provided by an image display device (not illustrated). Considering the support force and the transparency, the base substrate 110 may be preferably made of polyethyleneterephthalate (PET), polycarbonate (PC), polymethylmethacrylate (PMMA), polyethylenenaphthalate (PEN), polyethersulfone (PES), cyclic olefin copolymer (COC), triacetylcellulose (TAC) film, polyvinyl alcohol (PVA) film, polyimide (PI) film, polystyrene (PS), biaxially oriented polystyrene (BOPS; containing K resin), glass, tempered glass, or the like, but the material forming the base substrate 110 is not necessarily limited thereto.

Referring to FIGS. 1 to 3, the electrode patterns 120 and 130 serve to generate a signal when being touched by the input device so as to allow a controller to recognize touched coordinates and is formed on the base substrate 110. According to the preferred embodiment of the present invention, an electrode pattern formed in an X-axis direction of the base substrate 110 is named as the first electrode pattern 120 and an electrode pattern formed in a Y-axis direction of the base substrate 110 is named as the second electrode pattern 130.

The electrode patterns 120 and 130 may be formed by a plating process or a depositing process using a sputter. It is apparent to those skilled in the art that the electrode patterns 120 and 130 may use metal formed by exposing/developing a silver salt emulsion layer and may use various kinds of materials which may form a mesh pattern using a conductive metal. The electrode patterns 120 and 130 may be formed in all the patterns, such as a diamond pattern, a quadrangular pattern, a triangular pattern, and a circular pattern, which are known to those skilled in the art.

The electrode patterns 120 and 130 are formed on the base substrate 110 as a bar pattern orthogonal to a bar pattern in one direction. A mutual type touch sensor may perform the touch driving by forming the electrode patterns 120 and 130 on both surfaces of the base substrate 110. Further, the diamond patterns, and the like is cross arranged on one surface the base substrate 110 to be orthogonal to each other by using a bridge which is an insulating material to form the electrode pattern 120 on the one base substrate 110, thereby implementing the touch sensor module 1.

The electrode wirings 150 and 160 electrically connect the foregoing electrode patterns 120 and 130 to the flexible cable 300. The electrode wirings 150 and 160 may be formed on the base substrate 110 by various printing methods, such as a silk screen method, a gravure printing method, and an inkjet printing method (see FIG. 3). Here, the electrode wirings 150,160 may be made of copper (Cu), aluminum (Al), gold (Au), silver (Ag), titanium (Ti), palladium (Pd), and chromium (Cr). The electrode wirings 150 and 160 may be made of silver (Ag) paste or organic silver having excellent electrical conductivity. However, the electrode wirings 310 and 320 are not necessarily made of the silver (Ag) paste or the organic silver, but may be made of a conductive polymer, carbon black (including CNT), metal oxide such as ITO, a low resistance metal material such as metals, and the like.

The electrode wiring 160 is connected only to one end of the electrode pattern 120 depending on the touch sensor module 1 type. Distal portions of the electrode wirings 150 and 160 are provided with the electrode pads 140 which are electrically connected to the flexible cable 300. In other words, portions of the electrode wirings 150 and 160 are provided with the electrode pads 140 which are electrically connected to the flexible cable 300.

The electrode pads 140 are disposed on the base substrate 110 while being connected to the electrode wirings 150 and 160 (see FIG. 3). The electrode pad 140 is formed so as not to invade an active region of the flexible cable 300 and the base substrate 110, that is, a region in which a touch of a user is recognized. The electrode pad 140 is disposed at one end of the base substrate 110 to be connected to the electrode wirings 150 and 160. The electrode pad 140 contacts the adhesive layer 200 to conduct electricity to the flexible cable 300. The electrode pad 140 is coupled with the adhesive layer 200 by pressing the flexible cable 300. In this case, the electrode pad 140 is coupled with the adhesive layer 200 in a stacked direction of the base substrate 110. The electrode pad 140 is provided with a contact surface which contacts a conductive ball 220 of the adhesive layer 200. A diameter of the contact surface is formed to be larger than that of the conductive ball 220. The plurality of electrode pads 140 are disposed at one end of the base substrate 110. In this case, the electrode pads 140 are formed to be spaced apart from each other at a predetermined distance to prevent an electrical interference from occurring at the adjacent electrode pads.

In order to more improve moisture resistance and anti-environment characteristics of the touch sensor module 1, the passivation layer is used to prevent the infiltration of moisture.

The passivation layer 400 is formed to correspond to the electrode pad 140 (see FIGS. 1 and 2). The passivation layer 400 prevents moisture from being infiltrated into the electrode patterns 120 and 130, the wirings 150 and 160, and the electrode pad 140. The passivation layer 400 may have an insulating layer made of silicon dioxide (SiO₂) or silicon nitride (SiN) or a composite structure including the same, or may be made of materials such as polyimide and epoxy.

A first passivation layer 410 coats one end of the electrode pad 140. The first passivation layer 410 prevents the infiltration of moisture while protecting an active surface of the electrode patterns 120 and 130 and the electrode pad 140. The first passivation layer 410 is formed to be larger by 1 to 8 μm than a surface of the electrode pad 140, in consideration of a hardening rate of the adhesive layer 200. This resins (seals) an inside of the adhesive layer 200 by pressure at the time of coupling the flexible cable 300. That is, the electrode pad 140 is protected by preventing external moisture from being infiltrated thereinto along a boundary surface between the flexible cable 300 and the adhesive layer 200. The first passivation layer 410 prevents moisture from being infiltrated into the surface by coating the electrode patterns 120 and 130, the wirings 150 and 160, and the electrode pad 140. Therefore, the first passivation layer 410 prevents moisture from being infiltrated along the boundary surface between the flexible cable 300 and the adhesive layer 200, while preventing the moisture from being infiltrated into the surfaces of the electrode patterns 120 and 130 and the wirings 150 and 160. The first passivation layer 410 coats the flexible cable 300 and the electrode pad 140 to overlap each other, and thus a step is generated due to the first passivation layer 410, thereby applying a larger pressure. Therefore, the hardening rate of the adhesive layer 200 is more increased due to pressure. Considering the characteristics of the adhesive layer 200, this prevents moisture and humidity from being infiltrated as the hardening rate is increased, such that the infiltration path into the sensor may be blocked.

In some cases, a third passivation layer 450 is formed on the other surface of the base substrate 110 on which the first passivation layer 410 is formed, such that the electrode patterns 120 and 130, the wirings 150 and 160, the electrode pad 140, and the surface of the base substrate 110 may be coated.

The adhesive layer 200 is electrically connected the electrode pad 140 by contacting the electrode pad 140. When the adhesive layer 200 is coupled or adhered by pressure, the conductive ball 220 is disposed therein. The conductive ball 220 conducts electricity in one direction while the electrode pad 140 and the terminal part 320 are adhered to each other by the pressure during the coupling process. A lower section of the adhesive layer 200 is connected to the electrode pad 140 and an upper section of the adhesive layer 200 is adhered to the terminal part 320. That is, one surface of the conductive ball 220 in the adhesive layer 200 is adhered to the electrode pad 140 and the other surface thereof is adhered to the terminal part 320. This is to limit the shape in which the adhesive layer 200 is adhered to the electrode pad 140 and the terminal part 320.

The adhesive layer 200 may be preferably formed of an anisotropic conductive film (ACF). In some cases, the adhesive layer 200 may be made of a conductive material such as an anisotropic conductive adhesive (ACA).

The flexible cable 300 is correspondingly coupled to the electrode pad 140. The flexible cable 300 includes terminal parts 320 and 330 which contact the adhesive layer 200. The flexible cable 300 electrically connects between the electrode patterns 120 and 130 and a control unit (not illustrated) while being electrically connected to the electrode pad 140. The terminal parts 320 and 330 are electrically connected to the conductive ball 220. The terminal parts 320 and 330 are formed at a position corresponding to the plurality of electrode pads 140. The terminal parts 320 and 330 are coupled with the electrode pad 140 by the resin generated due to the pressure at the time of being coupled with the adhesive layer 200. In this case, when the coupling is easily made due to the step between the terminal parts 320 and 330 and the electrode pad 140, a force may be equally applied.

Referring to FIG. 4, in the touch sensor module 1 of a first modification example according to the preferred embodiment of the present invention, the description of the structure and material of the base substrate 110, the adhesive layer 200, the flexible cable 300, and the first passivation layer 410 which are the same components as the first modification example are omitted and the electrode patterns 120 and 130 which are the first modification example according to the preferred embodiment of the present invention will be described in detail.

The electrode patterns 120 and 130 are formed on one surface of the base substrate 110, in which the touch sensor is formed by the electrode patterns 120 and 130 of a single layer. In the touch sensor module of the first modification example according to the preferred embodiment of the present invention, the first electrode pattern 120 in the X-axis direction and the second electrode pattern 130 in the Y-axis direction crossing the first electrode pattern 120 may be formed on the base substrate 110 (see FIG. 5). An insulating pattern I is formed on any one electrode pattern at a portion at which the first electrode pattern 120 and the second electrode pattern 130 cross each other so that the first electrode pattern 120 and the second electrode pattern 130 are formed on the single surface to cross each other, and another electrode pattern is electrically connected on the insulating pattern I, such that the electrical connection between the first electrode pattern 120 and the second electrode pattern 130 which cross each other may be made. A crossing angle between the first electrode pattern 120 and the second electrode pattern 130 which cross each other is perpendicular, but the cross angle is not specifically limited. Therefore, it is preferable to cross the first electrode pattern 120 and the second electrode pattern 130 at a proper angle to extract X-axis and Y-axis coordinates on a two-dimensional plane.

The electrode patterns 120 and 130 are formed on one surface of the base substrate 110. As described above, in the touch sensor module of the first modification example according to the preferred embodiment of the present invention, the first electrode pattern 120 and the second electrode pattern 130 which cross each other may be simultaneously formed on one surface of the base substrate 110. Herein, the electrode patterns 120 and 130 may be formed in a mesh pattern which is formed as a metal fine line, in which the mesh pattern has a polygonal shape, such as a quadrangular shape, a triangular shape, and a diamond shape, but the shape of the mesh pattern is not particularly limited. The electrode patterns 120 and 130 may be formed in the mesh pattern using copper (Cu), aluminum (Al), gold (Au), silver (Ag), titanium (Ti), palladium (Pd), chromium (Cr), nickel (Ni) or a combination thereof.

An example of a method of forming the electrode pattern 120 may include a dry process, a wet process, or a direct patterning process. Here, the dry process includes sputtering, evaporation, and the like, the wet process includes dip coating, spin coating, roll coating, spray coating, and the like, and the direct patterning process means screen printing, gravure printing, inkjet printing, and the like.

Referring to FIG. 6, in the touch sensor module 1 according to the preferred embodiment of the present invention, the description of the structure and material of the electrode patterns 120 and 130, the base substrate 110, the adhesive layer 200, the flexible cable 300, and the first passivation layer 410 which are the same components as the preferred embodiment are omitted and a second passivation layer 420 which is the second preferred embodiment of the present invention will be described in detail.

The second passivation layer 420 is formed to coat a portion of the other portion of the electrode pad 140. The second passivation layer 420 coats a portion of the other end of the electrode pad while coating the surface of the base substrate 110. The second passivation layer 420 is formed to be equal to a height of the first passivation layer 410. Further, the second passivation layer 420 is formed along an edge of the base substrate 110. The second passivation layer 420 is formed to have the same height as the first passivation layer 410. This is to keep an equal pressure when the flexible cable 300 is coupled with the electrode pad 140. When the flexible cable 300 and the electrode pad 140 are not equally pressed, the flexible cable 300 is tilted in one direction, such that one portion thereof is pressed and the other portion thereof is expanded, thereby causing an electrical short.

In some cases, a third passivation layer is formed on the other surface of the base substrate on which the first passivation layer and the second passivation layer are formed, thereby coating the electrode pattern, the wiring, the electrode pad, and the surface of the base substrate.

In the touch sensor module 1 of the second modification example according to the preferred embodiment of the present invention, the description of the structure and material of the base substrate 110, the adhesive layer 200, the flexible cable 300, the first passivation layer 410, and the second passivation layer 420 which are the same components as the second preferred embodiment of the present invention are omitted and the electrode patterns 120 and 130 which are the second modification example according to the preferred embodiment of the present invention will be described in detail.

The electrode patterns 120 and 130 are formed on one surface of the base substrate 110, in which the touch sensor is formed by the electrode patterns 120 and 130 of the single layer. In the touch sensor module of the first modification example according to the preferred embodiment of the present invention, the first electrode pattern 120 in the X-axis direction and the second electrode pattern 130 in the Y-axis direction crossing the first electrode pattern 120 may be formed on the base substrate 110 (see FIG. 5). The insulating pattern I is formed on any one electrode pattern at the portion at which the first electrode pattern 120 and the second electrode pattern 130 cross each other so that the first electrode pattern 120 and the second electrode pattern 130 are formed on the single surface to cross each other, and another electrode pattern is electrically connected on the insulating pattern I, such that the electrical connection between the first electrode pattern 120 and the second electrode pattern 130 which cross each other may be made. The crossing angle between the first electrode pattern 120 and the second electrode pattern 130 which cross each other is perpendicular, but the cross angle is not specifically limited. Therefore, it is preferable to cross the first electrode pattern 120 and the second electrode pattern 130 at a proper angle to extract X-axis and Y-axis coordinates on a two-dimensional plane. The method of forming the electrode patterns 120 and 130 and the material thereof are the same as the electrode pattern of the first modification example as described above and therefore are omitted.

According to the preferred embodiments of the present invention, it is possible to prevent the short-circuit and the poor contact between the electrode pad and the FPCB by forming the passivation layers at both ends of the electrode pad.

Further, it is possible to prevent the electrical short-circuit between the electrode pad and the FPCB by forming the passivation layers at both ends of the electrode pad, thereby securing the reliability of products.

In addition, it is possible to prevent the distortion and tilting of the FPCB due to the pressure generated at the time of the coupling between the electrode pad and the FPCB, by forming the passivation layers at both ends of the electrode pad.

Moreover, it is possible to prevent the infiltration of moisture in both directions of electrode pad and the FPCB by forming the passivation layers at both ends of the electrode pad.

Also, it is possible to form the resin of the ACF ball in both directions of the electrode pad and the FPCB to prevent the short-circuit of the electrode pattern, by forming the passivation layers at both ends of the electrode pad.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch sensor module, comprising:
a flexible cable provided with a terminal part;
an adhesive layer formed to transfer an electrical signal by being contacted on one surface of the terminal part;
a base substrate including an electrode pad which is formed to correspond to the terminal part and formed to be contact on the other surface of the adhesive layer; and
a first passivation layer coating one end of the electrode pad.

2. The touch sensor module as set forth in claim 1, wherein the adhesive layer uses an anisotropic conductive film (ACF) or an anisotropic conductive adhesive (ACA).

3. The touch sensor module as set forth in claim 2, wherein a surface of the first passivation layer and a surface of the electrode pad are formed to have a step so as to increase a hardening rate of the adhesive layer.

4. The touch sensor module as set forth in claim 3, wherein the first passivation layer is formed to be larger by 1 μm to 8 μm than the surface of the electrode pad to increase the hardening rate and prevent infiltration of moisture.

5. The touch sensor module as set forth in claim 1, further comprising:
a second passivation layer formed to be coated along an outer circumferential surface of the electrode pad and formed to be equal to a height of the first passivation layer.

6. The touch sensor module as set forth in claim 1, further comprising:
a second passivation layer formed to coat the other end of the electrode pad and formed along an outer circumferential surface of the base substrate.

7. The touch sensor module as set forth in claim 6, wherein the first and second passivation layers are formed on surfaces of both ends of the electrode pad to have a step so as to increase the hardening rate and are formed to have the same height.

8. The touch sensor module as set forth in claim 7, wherein the first passivation layer and the second passivation layer are formed to be larger by 1 μm to 8 μm than the surface of the electrode pad to increase the hardening rate and prevent infiltration of moisture.

9. A touch sensor module, comprising:
a base substrate provided with an electrode pad;
a first passivation layer coating one end of the electrode pad in a thickness direction thereof;
an adhesive layer coupling the first passivation layer with the electrode pad; and
a flexible cable formed to correspond to the electrode pad and be electrically connected thereto in an area other than the first passivation layer.

10. The touch sensor module as set forth in claim 9, wherein the adhesive layer uses an anisotropic conductive film (ACF) or an anisotropic conductive adhesive (ACA).

11. The touch sensor module as set forth in claim 10, wherein a surface of the first passivation layer and a surface of the electrode pad are formed to have different steps so as to increase a hardening rate of the adhesive layer.

12. The touch sensor module as set forth in claim 11, wherein the first passivation layer is formed to be larger by 1 μm to 8 μm than the surface of the electrode pad to increase the hardening rate and prevent infiltration of moisture.

13. A touch sensor module, comprising:
a base substrate provided with an electrode pad;
a first passivation layer coating one end of the electrode pad in a thickness direction thereof;
a second passivation layer coating the other end of the electrode pad in a thickness direction thereof;
an adhesive layer crossing the first and second passivation layers to be filled in the electrode pad and coupled therewith; and
a flexible cable formed to correspond to the electrode pad and be electrically connected thereto in an area other than the first passivation layer and the second passivation layer.

14. The touch sensor module as set forth in claim 13, wherein the adhesive layer uses an anisotropic conductive film (ACF) or an anisotropic conductive adhesive (ACA).

15. The touch sensor module as set forth in claim 14, wherein the first and second passivation layers are formed on surfaces of both ends of the electrode pad to have a step so as to increase the hardening rate and are formed to have the same height.

16. The touch sensor module as set forth in claim 14, wherein the first passivation layer and the second passivation layer are formed to be larger by 1 μm to 8 μm than the surface of the electrode pad to increase the hardening rate and prevent infiltration of moisture.
